(19) United States
(12) Patent Application Publication
(10) Pub. No.: US 2013/0325509 A1
(43) Pub. Date: Dec. 5, 2013

(54) REFERRAL SYSTEM FOR PATIENT CARE PROVIDER

(71) Applicant: Thomas McCarrick, Short Hills, NJ (US)

(72) Inventor: Thomas McCarrick, Short Hills, NJ (US)

(21) Appl. No.: 13/906,090

(22) Filed: May 30, 2013

Related U.S. Application Data
(60) Provisional application No. 61/653,360, filed on May 30, 2012.

(51) Int. Cl. G06F 19/00; G06Q 50/24

(52) U.S. Cl. CPC G06F 19/324; G06Q 50/24
USPC 705/3; 705/2

(57) ABSTRACT

A system for managing patient care provider referral. The system includes a database which includes records for a plurality of patient care providers. The system also includes a processor, and a memory storing software executable by the processor. The software includes a lookup tool configured to retrieve patient care provider records from the database, and a transaction processing tool configured to enable a referring patient care provider to select a referred patient care provider for a patient based on the retrieved records. The system can further include an electronic health record (EHR) tracker configured to track updates to an EHR of the patient, as well as a survey tool configured to collect feedback from the patient regarding the referred patient care provider. Methods associated with the system and the various tools are also disclosed.

### CROSS-REFERENCE TO RELATED APPLICATIONS

This application claims priority to U.S. Provisional Patent Application No. 6,165,360 filed May 30, 2012, the disclosure of which is incorporated by reference herein in its entirety.

### BACKGROUND OF THE INVENTION

1. Field of the Invention

The present invention generally relates to a patient care provider referral system. Particularly, the present invention relates to a system including a user-accessible and user-updatable database containing information about physicians/specialists, such as cost data, quality data, feedback data, and rank data.

2. Description of the Related Art

A variety of methods and systems are known for enabling physicians to refer patients to other physicians, such as medical specialists, and ancillary services, such as physical therapy or nursing homes. For example, databases containing information such as physician information, specialty, and insurance information are known. Referring physicians may use these databases to help make an informed referral to a patient. For example, a referring physician, e.g., a primary-care doctor, may need to refer a patient to a specialist, e.g., a dermatologist. In order to refer the patient to a specialist who accepts the patient's insurance, the referring physician may first use a conventional database to confirm those specialists who accept the patient's insurance.

There is a developing need to provide referring physicians with further details concerning specialists. Not only will this enable the referring physician and the referring physician's staff to make more informed referrals, it will also benefit other stakeholders, such as specialists, hospitalists, insurance carriers, accountable-care organizations, and transaction processors, by helping ease the burden and lower the high administrative costs of managing referrals.

As is evident from the related art, conventional methods and systems have not provided the detail and functionality necessary for improving the referral process for both referring physicians and other stakeholders. There thus remains a need for an efficient and economic method and system for improving the physician referral process.

### SUMMARY OF THE INVENTION

The purpose and advantages of the disclosed embodiments of the invention will be set forth in and be apparent from the description that follows, as well as will be learned by practice of the disclosed embodiments. Additional advantages of the disclosed embodiments will be realized and attained by the methods and systems particularly pointed out in the written description, as well as from the drawing.

To achieve these and other advantages, and in accordance with the purpose of the disclosed embodiments of the invention, as embodied and broadly described, the present invention provides a system for managing patient care provider referral. The system includes a database which contains records for a plurality of patient care providers. The database can be stored in one or more permanent storage devices. The system also includes a processor, and a memory operably coupled to the processor and storing software executable by the processor. The software includes a lookup tool configured to retrieve one or more records of the plurality of patient care providers from the database, and a transaction processing tool configured to enable a referring patient care provider to select a referred patient care provider for a patient based on the one or more records of the patient care providers retrieved from the database.

In some embodiments, the lookup tool is further configured to present a user interface on a computing device that allows the referring patient care provider to input search criteria to perform a search query to retrieve one or more records of the patient care providers from the database that satisfy the search criteria. In some embodiments, the transaction processing tool is further configured to send a referral notice to at least one of the referring patient care provider, the referred patient care provider, the patient, a payor entity for the patient, and another entity designated by the referring patient care provider.

In some embodiments, the system further includes an electronic health record (EHR) tracker configured to track updates to an EHR of the patient. In some of such embodiments, the patient's EHR includes information regarding an activity or event concerning the patient and relating to the referred patient care provider, and the EHR tracker is further configured to track any update to the patient's EHR regarding the activity or event. In some of such embodiments, the EHR tracker is further configured to send a notice regarding the activity or event to a referring patient care provider or a payor entity for the patient.

In some embodiments, the system further includes a survey tool configured to collect feedback from the patient regarding the referred patient care provider. In some of such embodiments, the survey tool is further configured to update the record of the referred patient care provider in the database to include the patient's feedback.

Methods of operating the system described herein are also provided, as will be further described below.

It is to be understood that both the foregoing general description and the following detailed description are exemplary and are intended to provide further explanation of the disclosed invention and the embodiments.

The accompanying drawings, which are incorporated in and constitute part of this specification, are included to illustrate and provide a further understanding of the method and system of the embodiments of the invention. Together with the description, the drawings serve to explain the principles of the invention.

### BRIEF DESCRIPTION OF THE DRAWINGS

The various aspects and embodiments disclosed herein will be better understood when read in conjunction with the drawings. For the purposes of illustrating aspects of the present application, there are shown in the drawings certain preferred embodiments. It should be understood, however, that the application is not limited to the precise arrangement, structures, features, embodiments, aspects, and devices shown, and the arrangements, structures, features, embodiments, aspects, and devices shown may be used singularly or in combination with other arrangements, structures, features, embodiments, aspects, and devices. The drawings are not necessarily drawn to scale and are not in any way intended to limit the scope of this invention, but are merely presented to clarify illustrated embodiments of the invention.

FIG. 1 is a block diagram depicting a system in accordance with an embodiment of the present invention; and

FIG. 2 is a block diagram of hardware used to implement a system in accordance with an embodiment of the present invention.

### DETAILED DESCRIPTION OF CERTAIN EMBODIMENTS

Reference will now be made in detail to preferred embodiments of the invention, an example of which is illustrated in the accompanying drawings. The method and corresponding steps of the disclosed embodiments of the invention will be described in conjunction with the detailed description of the corresponding system.

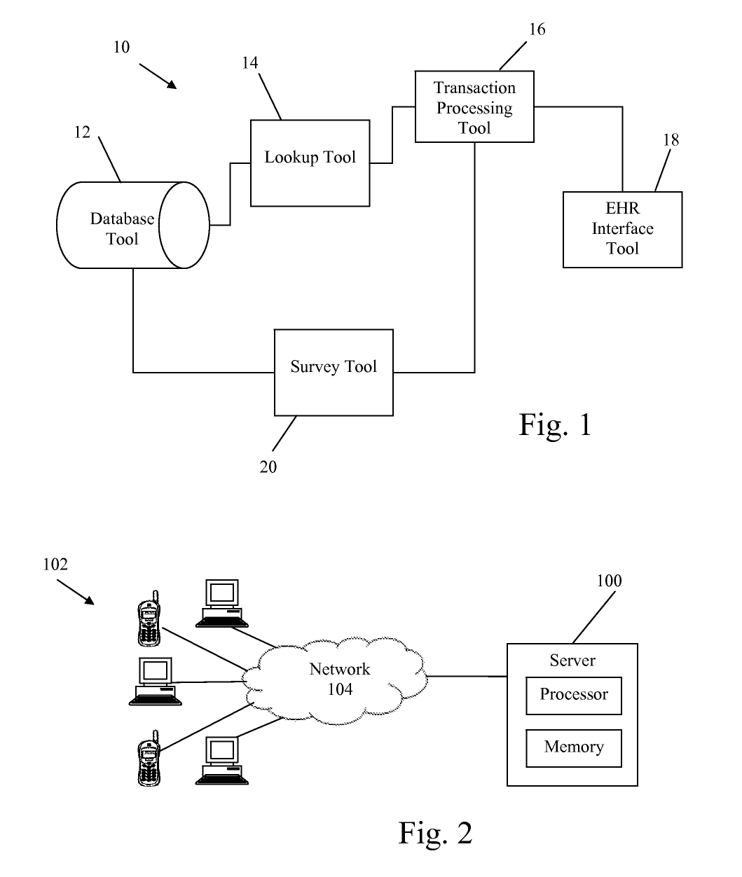

The methods and systems presented herein may be used for a user to identify certain patient care providers and refer patients to these patient care providers. The disclosed embodiments of the invention are particularly suited for providing information to a referring patient care provider, such as a physician (e.g., a primary care physician), a medical specialist, a care-providing organization (e.g., a hospital, a clinic, etc.), about a referred patient care provider such as a physician, a medical specialist, a nurse, or a care-giving organization. In some illustrative embodiments as discussed below, and for brevity of description herein, a referring patient care provider of the present invention is a physician such as a primary care physician, and the referred patient care provider is a medical specialist. It is understood, however, that any other patient care provider can be the referrer or the person/entity referred in the system described herein. Embodiments of the invention can further enable patient care providers and patients to provide feedback concerning the patient care providers, and processing any transactions relating thereto. For purpose of explanation and illustration, and not limitation, an exemplary embodiment of the system in accordance with the invention is shown in FIG. 1.

As shown in FIG. 1, in one embodiment, the system 10 includes five primary components: a database 12, a lookup tool 14, a transaction processing tool 16, an Electronic Health Records (“EHR”) tracker or interface 18, and a survey tool 20.

In one embodiment, database 12 may be stored on a user computing device, such as a local computer, which has a processor and memory operably coupled thereto and containing software instructions to be executed by the processor. In another preferred embodiment, database 12 may be stored on a non-local computer such as server 100 communicatively coupled (either via a network or a local link) with the user computing device, the non-local computer having a processor and memory operably coupled thereto and containing software instructions to be executed by the processor to perform the functions of the various tools described herein. In another embodiment, database 12 may be stored along with any of lookup tool 14, transaction processing tool 16, electronic health records (“EHR”) tracker 18, and survey tool 20 as part of a local or non-local computer. In a further embodiment, the database may be stored on a plurality of server 100. Database 12 may be accessible by a user, e.g., a referring physician, a medical specialist, a transaction processor (e.g., NaviNet, Inc.), or a patient, via computing devices 102. Computing devices 102 may include, e.g., desktop computers, laptop computers, Personal Digital Assistants (PDAs), smart phones, or the like. In some embodiments, database 12 can be included in the computing devices 102. Alternatively, computing devices 102 may be used to access server 100 and database 12 over a network 104, such as the Internet, an intranet, a WAN, a LAN, virtual private network (VPN), etc. Server 100 may serve, e.g., web pages to end users that allow the end users to, e.g., search database 12 for information about patient care providers, provide reviews about the patient care providers, and rank the patient care providers.

Database 12 contains, e.g., information relating to patient care providers, including referring patient care providers and referred patient care providers. This information may include, for each patient care provider: name; contact information (such as address, phone number, e-mail address, website, instant messaging, and social media contact); indications of the patient care provider's specialties and level of experience in these specialties; feedback, ratings, experiences, testimonials, and rankings of the patient care provider provided by other patient care providers; feedback, ratings, experiences, testimonials, and rankings of the patient care provider provided by patients; a list of insurance providers that are accepted by the patient care provider; cost data, such as a cost menu for various procedures offered by the patient care provider; quality data, such as a detail of a physician's skill, effectiveness, procedures used, and equipment used. This information may further include ranking data for a user's preferences concerning each patient care provider in the database. This information may also include indications of whether the patient care provider is accepting new patients, patients referred from other doctors, and whether the patient care provider accepts walk-in appointments. These types of information are exemplary and do not constitute an exhaustive list of the types of information that may be included in database 12. In accordance with an embodiment of the present invention, the information may additionally include other types of information. This information may be provided by physicians, specialists, patients, insurance companies, affordable care organizations, Medicare, or any other individual or organization with information about a physician or specialist relating to the present invention.

In a preferred embodiment, the system includes a lookup tool 14. The lookup tool allows a user, such as a referring physician, to access the information and data in the database using a computing device 102. In some embodiments, this tool may be software (and, optionally, associated hardware for implementation) that is resident on a computing device used by a referring patient care provider, such as a computer, smart phone, or PDA. In other embodiments, the lookup tool may be resident in a remote server, e.g., server 100, or a cloud-computing system, and may be remotely accessed by the computing device, e.g., via a web-based user interface. In some embodiments, the lookup tool includes a user interface that allows a user to input search criteria to perform a search query of the database. The search criteria may include, e.g., name, specialty, insurance, location, rankings, ratings, or any other type of information of the patient care providers contained within the database. In some embodiments, the user interface includes an output device such as a computer monitor or smart phone display upon which a user may review the results of the search query of the database.

In a preferred embodiment, the system includes a transaction processing tool 16. In some embodiments, the transaction processing tool permits a referring physician or a patient to choose a specialist to which a patient is being referred. The tool may record this choice and send a referral notice to the referred specialist. Additionally, the tool may send a referral notice to an insurance carrier or other payor entity, such as an accountable-care organization (“ACO”). The transaction processing tool may also send a referral notice to a patient. These notices may be in the form of an e-mail, text message, phone call, voice mail, calendar appointment, paper notice, or the like. The transaction processing tool may be software (and, optionally, associated hardware for implementation) that is resident on a computing device 102, such as a computer, a smart phone, or a PDA. In other embodiments, the transaction processing tool may be resident in a remote server, e.g., server 100, or a cloud-computing system, and may be remotely accessed by the computing device, e.g., via a web-based user interface.

In a preferred embodiment, the system includes an EHR tracker or interface 18. EHR, or Electronic Health Record, is a collection of electronic health information about an individual patient or a population of patients. It is generally a record in digital format that may be shared across different healthcare settings. In some cases this sharing can occur by way of network-connected, enterprise-wide information systems and other information networks or exchanges. EHRs may include a range of data, including demographics, medical history, medication and allergies, immunization status, laboratory test results, radiology images, vital signs, personal statistics such as age and weight, and billing information. In accordance with embodiments of the present invention, an EHR may further include information obtained from database 12 and information provided by transaction processing tool 14. Additionally, an EHR may further include any information relating to a patient's interactions, discussions, appointments, and payments to a referred patient care provider. Such information may be input into database 12 by an end-user, such as a patient or a physician. Alternatively, the information may be input into database 12 by an operator who receives such information from the end-user. Such an operator may be, e.g., an employee of an organization that maintains and operates any or a plurality of the embodiments of the present invention.

The EHR tracker or interface 18 may be software (and, optionally, associated hardware for implementation) that is resident on a computing device 102, such as a computer, a smart phone, or a PDA. In other embodiments, the EHR tracker may be resident in a remote server, e.g., server 100, or a cloud-computing system, and may be remotely accessed by the computing device, e.g., via a web-based user interface. The EHR tracker may track any updates to a patient's EHR. In some embodiments, the EHR tracker may provide notices and updates to a referring patient care provider, particularly with respect to any information that is updated concerning the referred patient care provider, such as a medical specialist. Such notice may be provided, e.g., from server 100 to a computing device 102. The EHR tracker may also provide scheduling reminders to a patient who has not scheduled an appointment with a referred specialist during a pre-defined time window set by the referring physician. Again, such notices may be provided, e.g., to the patient from the server 100 to a computing device 102 accessible by the patient. In some embodiments, the EHR tracker may provide updates concerning interactions between a referred specialist and a patient to a payor, such as an insurance provider or ACO, to facilitate billings and payments between the physician, specialist, payor, and patient. A person having ordinary skill in the art will understand that all of the information within an EHR may be monitored and tracked by a single tool, such as EHR tracker or interface 18. Alternatively, different types of information may be monitored and tracked by more than a single tool that together may make up an overall EHR tracker or interface 18. For example, in some embodiments, EHR tracker or interface 18 may include multiple sub-tools that may be integrated into a single EHR tracker or interface 18. Alternatively, in some embodiments, the sub-tools may operate independently of each other as stand-alone tools. In some embodiments, a first sub-tool may monitor any changes to a patient's health history, a second sub-tool may monitor any changes to a patient's personal information (e.g., an address change), and a third sub-tool may monitor any changes relating to referral information (e.g., referral of a patient to a referred specialist, or a patient's appointment date and time with a referred specialist).

In a preferred embodiment, the system includes a survey tool 20. Survey tool 20 may be software (and, optionally, associated hardware for implementation) that is resident on a computing device 102, such as a computer, a smart phone, or a PDA. In other embodiments, the survey tool may be resident in a remote server, e.g., server 100, or a cloud-computing system, and may be remotely accessed by the computing device, e.g., via a web-based user interface. In some embodiments, the survey tool solicits and collects feedback from a patient about the patient's experiences concerning a referred patient care provider. Additionally and alternatively, the survey tool may solicit and collect feedback from a referring patient care providers about referring patient care provider's experiences concerning referred patient care provider. The survey tool may collect this information in the form of reviews, testimonials, etc. The survey tool may request this information from patients and referring patient care providers by, e.g., mailing or emailing a questionnaire containing questions about the referred patient care provider to the patient or the referring patient care provider. In other embodiments, the survey may be provided on a website. To aid the patient or a referring physician in completing the questionnaire, the patient or the referring physician may receive a fee, or be entered into a contest to win a prize. In some embodiments, the survey tool may update the database with any information collected by the survey tool. In some embodiments, the survey tool may flag errors for later review or analysis. In some embodiments, the survey tool is maintained by an organization or company that may review and correct any such errors.

As mentioned above, the database may be accessed using a software program. This software program may include additional features in accordance with embodiments of the invention to further aid a referring patient care provider in referring a patient to a referred patient care provider. For example, the software may include a ranking tool by which a referring physician user may assign rankings to medical specialists based on the referring physician's personal preferences. Such ranking would allow a referring patient care provider to add his or her own criteria to data obtained from the database concerning these referred patient care providers. For example, the rankings may be based on diseases or conditions, the referred specialist's hospital affiliation, types of insurance the specialist accepts, the referring physician's past experience with the specialist, or the referred specialist's sub-specialties. This would enable a referring physician to search for medical specialists by such ranks Moreover, this would enable the referring physician to create custom lists of medical specialists for the referring physician's staff and patients to use.

The software program may also include additional features, such as secure messaging between physicians in accordance with the Health Insurance Portability and Accountability Act. In other embodiments, the software program may provide educational content about relevant topics in healthcare, such as “care collaboration.” Completion of any educational activity may be tracked in the database.

In accordance with various embodiments of the invention, the various embodiments disclosed above may be used to carry out various methods for identifying medical specialists, referring patients to medical specialists, accessing a database containing relevant information concerning the specialists, updating this database, and collecting feedback about the specialists. For example, during a patient's visit to her primary care physician, the referring physician may determine that the patient should visit a medical specialist, such as a dermatologist. The referring physician may therefore wish to refer the patient to such a medical specialist. Additionally, certain insurance companies require that a referring physician provide a reference of a medical specialist to a patient as a condition precedent to the patient receiving insurance benefits from any visit to a specialist.

The referring physician may use any of the embodiments of the system in accordance with the present invention to determine a specialist or specialists to which the patient may be referred. For example, the referring physician may use a computing device 102, such as a smart phone, to access database 12. In some embodiments, the referring physician may access database 12 using lookup tool 14, which may be resident on computing device 102. The referring physician may use the user interface of lookup tool 14 to input search criteria to perform a search query of the database. For example, the referring physician may input search criteria such as: a type of medical specialist (e.g., dermatologist), a brand of insurance accepted (e.g., the brand of insurance for which the patient possesses a policy), a location (e.g., within a predetermined distance from the patient's home), a rank based on the referring physician's pre-determined preferences based on, e.g., hospital affiliation and the referring physician's past experiences with the medical specialist, and reviews based on patient feedback. In some embodiments, user interface of lookup tool 14 includes an output device such as a smart phone display. Using this output device, the referring physician may view those specialists that match the search criteria input by the referring physician. Using this information, the referring physician may refer the patient to one or more of these specialists.

In some embodiments of the present invention, the referring physician and/or the patient may use transaction processing tool 16 to choose one or more specialists to whom the referring physician is referring the patient. The transaction processing tool may record this choice. In some embodiments, the referring physician may also specify a pre-determined time window within which the patient should visit the referred specialist. Additionally, the transaction processing tool may send a notification about the referral to any one or more of the referring physician, the referred specialist, the patient, the patient's insurance carrier, or any other person or party designated by the referring physician. In various embodiments, this notification may be provided in the form of, e.g., an e-mail.

In some embodiments of the present invention, an end-user (e.g., a referring physician, a patient, an insurance company, or an employee of an organization that maintains any of the embodiments of the systems of the present invention) may wish to refer to an EHR concerning the patient to, for example, determine whether the patient has visited the specialist during the pre-determined time window. Alternatively, the end-user may wish to update the EHR with information about the patient such as, for example, information concerning the patient's visit to the specialist. The end-user may access the EHR using EHR tracker or interface 18. Alternatively, EHR tracker or interface 18 may provide an automated update to an end user concerning any changes made to the patient's EHR. Such notification could, for example, facilitate billings and payments between any of the physician, specialist, insurance company, and patient.

In some embodiments of the present invention, survey tool 20 may solicit and collect feedback from a patient and/or a referring physician concerning the patient's and referring physician's experiences with the specialist. The collected information may include information such as reviews, testimonials, etc. For example, in some embodiments, the patient may be provided with a survey or a list of multiple choice questions and be asked to provide the requested information within a pre-determined time window. In some embodiments the patient and/or referring physician may access the survey, e.g., on a website and complete the survey thereon. Upon receiving a completed survey, survey tool 20 may cause database 12 to be updated with some or all of the information in the completed survey. In some embodiments, database 12 may be updated manually with the survey information by an employee of a company that maintains and operates any of the systems in accordance with the embodiments of the present invention.

While the invention is described herein in terms of certain preferred embodiments, those skilled in the art will recognize that various modifications and improvements may be made to the embodiments without departing from the scope of the invention. Moreover, although individual features of one embodiment of the invention may be discussed herein or shown in the drawing, it should be apparent that individual features of one embodiment may be combined with one or more features of another embodiment or features from a plurality of embodiments.

The disclosed subject matter is also directed to other embodiments of the invention having any other possible combination, or lack thereof, of the features disclosed above. As such, the particular features disclosed above can be combined with each other in other manners within the scope of the invention such that invention should be recognized as also specifically directed to other embodiments having any other possible combinations. Thus, the foregoing description of specific embodiments of the invention has been presented for purposes of illustration and description. It is not intended to be exhaustive or to limit the disclosed subject matter to those embodiments disclosed.

It will be apparent to those skilled in the art that various modifications and variations can be made in the method and system of the disclosed embodiments of the invention without departing from the spirit or scope of the invention. Thus, it is intended that the invention includes modifications and variations that are within the scope of the appended claims and their equivalents.

What is claimed is:

1. A system for managing patient care provider referral, comprising:
a database comprising records for a plurality of patient care providers;
a processor;
a memory operably coupled to the processor and storing software executable the processor, the software including:
a lookup tool configured to retrieve one or more records of the plurality of patient care providers from the database; and
a transaction processing tool configured to enable a referring patient care provider to select a referred patient care provider for a patient based on the one or more records of the patient care providers retrieved from the database.

2. The system of claim 1, wherein the lookup tool is further configured to present a user interface on a computing device that allows the referring patient care provider to input search criteria to perform a search query to retrieve one or more records of the patient care providers from the database that satisfy the search criteria.

3. The system of claim 1, wherein the transaction processing tool is further configured to send a referral notice to at least one of the referring patient care provider, the referred patient care provider, the patient, a payor entity for the patient, and another entity designated by the referring patient care provider.

4. The system of claim 1, further comprising an electronic health record (EHR) tracker configured to track updates to an EHR of the patient.

5. The system of claim 4, wherein the patient's EHR includes information regarding an activity or event concerning the patient and relating to the referred patient care provider, and wherein the EHR tracker is further configured to track any update to the patient's EHR regarding the activity or event.

6. The system of claim 5, wherein the EHR tracker is further configured to send a notice regarding the activity or event to a referring patient care provider or a payor entity for the patient.

7. The system of claim 5, wherein the EHR tracker is further configured to send a reminder to the patient regarding scheduling an appointment with the referred patient care provider if the patient has not scheduled an appointment during a predefined time window set by the referring patient care provider at the time the referring patient care provider selects the referred patient care provider for the patient.

8. The system of claim 1, further comprising a survey tool configured to collect feedback from the patient regarding the referred patient care provider.

9. The system of claim 8, wherein the survey tool is further configured to update the record of the referred patient care provider in the database to include the patient's feedback.

10. The system of claim 1, wherein the referred patient care provider is a medical specialist.

11. The system of claim 1, wherein the referring patient care provider is a physician.

12. The system of claim 1, wherein the records of the patient care providers in the database include at least one of, for each patient care provider: name and contact information; specialty or specialties; a level of experience in the specialty or specialties; comments from other patient care provider; comments from patients; a list of insurance providers the patient care provider accepts; cost data of the patient care provider; quality data of the patient care provider; and a referring patient care provider's preference.

13. The system of claim 1, wherein the database is included in one or more computer servers, and the processor are included in a computer device, the computing device and the one or more computer servers being communicatively coupled to each other via a local link or via a network.

14. The system of claim 1, wherein the software is, at least in part, resident in a memory of the computing device.

15. The system of claim 1, wherein the software is, at least in part, resident in a memory of the one or more computer servers.

16. A system for managing patient care provider referral, comprising:
a processor;
a database comprising records for a plurality of patient care providers;
a memory operably coupled to the processor and storing software instructions executable by the processor, the processor being operable when executing the instructions to:
retrieve one or more records of the patient care providers from the database based on a search using an input search criteria entered by a referring patient care provider;
receive a selection, by the referring patient care provider, of a referred patient care provider for a patient based on the retrieved one or more records of the patient care providers;
track an update to the patient's EHR regarding an activity or event concerning the patient and relating to the referred patient care provider; and
update the record of the referred patient care provider in the database to include patient's feedback, if any, regarding the referred patient care provider.

17. A computer-implemented method for managing patient care provider referral, comprising:
retrieving, from a database included in one or more computer servers, one or more records for a plurality of patient care providers;
receiving, at a computing device communicatively coupled to the one or more computer servers via a local link or via a network, a selection by a referring patient care provider, of a referred patient care provider based on the one or more records of the patient care providers retrieved from the database; and
tracking, using a computer processor, an update to an EHR of the patient regarding an activity or event concerning the patient and relating to the referred patient care provider.

18. The method of claim 17, further comprising:
presenting a user interface on the computing device, the user interface enabling the referring patient care provider to input search criteria to perform a search query to retrieve the one or more patient care provider records satisfying the search criteria.

19. The method of claim 17, further comprising:
electronically sending a referral notice to at least one of the referring patient care provider, the referred patient care provider, the patient, a payor entity for the patient, and another entity designated by the referring patient care provider.

20. The method of claim 17, wherein tracking the update to the patient's EHR further comprises:
tracking the patient's EHR regarding an activity or event concerning the patient and relating to the referred patient care provider.

21. The method of claim 20, further comprising:
electronically send a notice regarding the activity or event to a referring patient care provider or a payor entity for the patient.

22. The method of claim 17, wherein the referred patient care provider is a medical specialist.

23. The method of claim 17, wherein the referring patient care provider is a physician.

24. The method of claim 17, further comprising:
electronically receiving feedback from the patient regarding the referred patient care provider.

25. The method of claim 24, further comprising:
updating, using the computer processor, the record of the referred patient care provider in the database to include the patient's feedback regarding the referred patient care provider.
